(19) United States
(12) Patent Application Publication
(10) Pub. No.: US 2026/0208193 A1
(43) Pub. Date: Jul. 23, 2026

(54) IMPROVEMENTS IN OR RELATING TO A CARTRIDGE

(71) Applicant: LIGHTCAST DISCOVERY LTD, Cambridge (GB)

(72) Inventors: Thomas Henry ISAAC, Cambridge (GB); William DEACON, Cambridge (GB); Richard Jeremy INGHAM, Cambridge (GB); Timothy James PUCHTLER, Cambridge (GB); Robert WOOTON, Cambridge (GB); Gareth William Harry EVANS, Cambridge (GB); Brooke William LONGBOTTOM, Cambridge (GB); Matthew Paul WRIGHT, Cambridge (GB)

(73) Assignee: LIGHTCAST DISCOVERY LTD, Cambridge (GB)

(21) Appl. No.: 19/139,180

(22) PCT Filed: Dec. 13, 2023
(86) PCT No.: PCT/GB2023/053217

§ 371 Date: Jun. 13, 2025

(30) Foreign Application Priority Data
Dec. 14, 2022 (GB) 2218873.4

(51) Int. Cl. B01L 3/00

(52) U.S. Cl. CPC B01L 3/502792; B01L 3/502715; B01L 3/54; B01L 2200/025; B01L 2200/027; B01L 2200/0673; B01L 2200/143; B01L 2300/021; B01L 2300/042; B01L 2400/0427; B01L 2400/0487; B01L 2400/0644

(57) ABSTRACT

A cartridge is provided. The cartridge comprising at least one inlet port for introducing a sample into the cartridge; at least one emulsifier configured to produce microdroplets; a chip comprising a first and second composite walls having a microfluidic space therebetween for microdroplet manipulation; an emulsion handling channel configured to provide fluid communication between the emulsifier and the chip; and an aqueous handling channel for introducing aqueous media to the emulsifier.

The present invention relates to improvements in or relating to a cartridge and in particular, a cartridge comprising an emulsifier for producing microdroplets and a chip for microdroplet manipulation.

It is known that a cartridge can be provided to house a microfluidic chip and, in particular, an EWOD or oEWOD chip. Electrowetting-on-dielectric (EWOD) is a well-known effect in which an electric field applied between a liquid and a substrate reduces the contact angle to the surface in comparison to the natural state. The effect of electrowetting can be used to manipulate microdroplets by applying a series of spatially varying electrical fields on a substrate to modify the surface wettability.

A variant of this approach uses optically-mediated electrowetting forces to provide the motive force in a device for manipulating microdroplets. In this optically mediated electrowetting (oEWOD) device, the microdroplets are translocated through a microfluidic space defined by containing walls; for example a pair of parallel plates having the microfluidic space therebetween. At least one of the containing walls includes what are hereinafter referred to as ‘virtual’ electrowetting electrode locations, which are generated by selectively illuminating an area of a semiconductor layer buried within. By selective illumination of the layer with light from a separate light source, controlled by an optical assembly, a virtual pathway of virtual electrowetting electrode locations can be generated transiently along which the microdroplets can be caused to move.

The cartridge also contains an emulsifier used to generate microdroplets that can be fed into the chip through a network of microfluidic channels. Efficient and effective transportation of the microdroplets into the chip, as well as providing sufficient fluids to the emulsifier for droplet generation on the cartridge are key to microdroplet operations via EWOD, oEWOD or other suitable microdroplet manipulation techniques. In particular, for the case where an oEWOD chip is required to handle a very large number of microdroplets in parallel, it is imperative that the emulsion is delivered to the oEWOD chip in a monodisperse and evenly-distributed state.

Thus, there is a requirement to provide a compact cartridge containing an emulsifier and an EWOD or oEWOD chip to enable efficient production and manipulation of multiple microdroplets. Furthermore, the design of the cartridge channels in the present invention is optimised such that the dispersion and integrity of the fluids, particularly biological fluids containing cells are preserved. It is also desirable to provide efficient transportation of fluids and/or biological components around the cartridge.

It is against this background that the present invention has arisen.

According to an aspect of the present invention, there is provided a cartridge comprising: at least one inlet port for introducing a sample into the cartridge; at least one emulsifier configured to produce microdroplets; a chip comprising a first and second composite walls having a microfluidic space therebetween for microdroplet manipulation; an emulsion handling channel configured to provide fluid communication between the emulsifier and the chip; and an aqueous handling channel for introducing aqueous media to the emulsifier.

The microdroplet manipulation may be configured to be performed by EWOD or oEWOD.

The cartridge according to the present invention provides an apparatus for transporting biological/chemical entities such as microbeads or cells from the emulsifier to a device for interrogation without damage to the cells.

The emulsifier may be, but is not limited to, a step emulsifier, a T-junction emulsifier, a cross flow emulsifier or a membrane emulsifier or any other device(s) for imparting shear to fluids. Such emulsifiers are configured to generate droplets of varying size, composition and density. They may generate emulsions with varying ratios of continuous and dispersed phase. Any of these parameters may influence the susceptibility of the droplets to merging, disintegration, electrolysis or other deleterious effects as they enter the device. Advantageously, the present invention allows for a wide range of emulsions and different emulsifier types to be used to supply the device.

Step emulsifiers have the advantage that the flow velocity of the dispersed or continuous phases does not directly influence the size of the microdroplets produced and therefore a monodisperse stream of microdroplets can be created with a varying flow velocity.

If step emulsifiers are used, there may be multiple nozzles provided at the outlet of each emulsifier. Increasing the number of nozzles provided increases the size of the emulsifier, but also increases the throughput. Furthermore, in the event that one of the nozzles at the outlet of the emulsifier is blocked, another nozzle can be used to continue producing microdroplets. The nozzle can be configured to drip an aqueous fluid into a carrier phase of oil. The, or each, nozzle is located at the intersection of a droplet buffer zone and a series of channels connecting from the inlet to the droplet buffer zone.

The selection of the number of nozzles in each emulsifier and the number of emulsifiers overall is therefore a balance between the real estate requirements of the cartridge and the microdroplet throughput requirements of the chip. The cartridge is not configured to store a substantial volume of microdroplets and therefore the rate of production of the microdroplets in the emulsifier must be substantially matched to the downstream processing of the microdroplets in the chip. The chip can be an oEWOD or EWOD chip. In some embodiments, there may be between 8 and 16 nozzles in each emulsifier and 8 emulsifiers in each cartridge.

The nozzle may be rectangular in cross-section or may be of a trapezoid profile with two drafted side walls. The profile has a nozzle height h, which largely determines the size of droplets that break off from the nozzle, and a characteristic width w. The width is always greater than the height. In the case of a trapezoid profile the sidewalls will have a draft angle in the range 0.1 to 10 degrees, most typically in the range 5 to 10 degrees.

The nozzle may be provided at an acute angle relative to the channel of the emulsifier. Aqueous fluid from the nozzle feeds out over the step wall. The step wall has a draft angle and the emulsifier works effectively with this draft angle. This is an unexpected result as the prior art has the step wall as 0-degree vertical drop.

Emulsifiers are known in the art where a gradient is provided such that the nozzle depth increases along the length of the flow path. Such a gradient in nozzle depth is in contrast to that seen in the device of the present invention, where a draft angle is present in the front face of the nozzle, and the nozzle depth itself is uniform throughout the nozzle structure.

The selection of the nozzle depth within the channel of the step emulsifier dictates the microdroplet size. This can be advantageous as the step emulsifiers within a single cartridge may provide a plurality of different nozzle depths and therefore microdroplet sizes. For example, a nozzle depth of 20 microns can generate a microdroplet size range of between 60 μm and 120 μm in diameter. The droplet diameter may further vary depending on the nature of the running fluids and the addition or removal of additives such as surfactants, density modifiers, viscosity modifiers. In particular, the droplet diameter may vary according to the composition of the aqueous fluid, where the aqueous fluid could be cell media of various formulations such as buffer solutions, protein mixtures, vitamins nutrients and salts. The droplets may have volumes in the range 80 pL to 800 pL; particularly in the range 87 pL to 143 pL for smaller sized droplets; particularly in the range 220 pL to 320 pL for intermediate-sized droplets and particularly in the range 380 pL to 800 pL for large-sized droplets. Droplets may also be formed with volumes greater than 800 pL. Having a range of droplet volumes supplied by the cartridge can be particularly useful for bead-based immunoassays.

The microdroplets generated by a nozzle may have a diameter of approximately four times the nozzle depth. The term “depth” as used herein is not intended to be limited to the vertical extent of the nozzle, although this is one possible configuration. The flows through the emulsifiers are not substantially influenced by gravity and therefore the emulsifier could be operated in any orientation.

The emulsion handling channels may have, but are not limited to, a rectilinear geometry, such as a square, rectangle or rhombus. The rhombus presentation is particularly applicable for certain manufacturing techniques, including injection moulding, where there is a required draft angle on all cross sections. Alternatively, the emulsion handling channel may have a substantially circular cross section. The diameter, major axis or width of the emulsion handling channel may be less than 500 microns, in some embodiments, less than 200 microns. In some embodiments, the emulsion handling channel may have a diameter, major axis or width of 200 to 500 microns in diameter, for example between 200 and 300 microns.

The channel dimensions and shapes of the emulsifier may be more or less constrained depending on the choice of the moulding technique being used. In some embodiments where soft lithography is used as the moulding technique, the channels may have vertical sidewalls and for some types of master, it may be challenging to manufacture sidewalls with any draft angle.

In some embodiments, where a hot-embossing technique is used, the sidewalls may optionally be drafted dependent on the choice of master manufacturer. For an injection moulding process, the design of the mould, the operating parameters and the choice of moulded material will affect the range of draft angles that can be achieved. For all of the factors mentioned herein, it is desirable to design an emulsifier that is robust to variation in the draft angle. The design of the emulsifiers of the present invention has been shown by the inventors to produce monodisperse droplets in the presence of draft angles. The mechanism of droplet break-off posited for this structure is the formation of elongated necks of fluids within the most confined region of the nozzle, wherein those necks are geometrically inclined to break above a certain length owing to the geometric mis-match between the neck and the extruded droplet on the other side of the nozzle front face. The addition of a draft angle to the nozzle front face does not alter the droplet volume of the break-off condition but acts only to extend the neck further beyond the nozzle at the point of break-off.

An aspect of the present invention relates to the maintenance of the integrity of the emulsion so that it moves, without disruption through the cartridge. This is achieved through careful choice of channel geometry and routing. This includes a configuration that is substantially without corners, by which it should be understood that the radius of curvature does not exceed 4 mm. Furthermore, the radius of curvature should be selected so that there should be substantially no sedimentation at running speeds. For example, a radius of greater than 4 mm with a flow rate of less than 10 μl/minute. Overall, laminar flow should be maintained.

In some embodiments, the cartridge may further comprise one or more vias connecting the emulsion handling channels. In some embodiments, the vias have substantially the same hydraulic diameter as the emulsion handling channels.

Emulsions are prone to disruption as they pass through microfluidic channels. In particular, the droplets within the channel may undergo coalescence, break-up under shear, ripening and changes to their packing fraction. Each of these disruptions can be induced by turns and corners in the emulsion-handling channels, and by the transit of vias that connect between layers in the cartridge structure. They may also be induced by transit over rough surfaces or surfaces that are hydrophilic. Advantageously the cartridge design permits the use of substantially straight channels for emulsion handling in which the emulsion can flow without disruptive corners. Where corners are present in the channel they are routed such that the radius of curvature is maximised. Where vias are necessary in the channel they are minimised in number and chosen such the hydraulic diameter of the via is matched to the hydraulic diameter of the channels which are interposed by said via.

In some embodiments, the vias can be tapered to provide a gradually changing hydraulic diameter. In some embodiments, the channels leading up to the vias can be tapered to provide a gradually changing hydraulic diameter.

In some embodiments, the aqueous handling channels can be substantially devoid of corners and have smooth sidewalls of dimension between 100 μm and 400 μm. The dimension of the sidewalls may be the channel height or width, if the channel is rectilinear. The height and width may be the same if the channel has a square cross section, for example. Alternatively, the dimension of the sidewall may be the diameter of a circular cross section channel or the major or minor diameter of an elliptical cross section channel. It will be readily apparent that the channel elongate extent, perpendicular to the dimension of the channel, will exceed the dimension of the channel. In other words, the channel has a considerably greater length than its height, width or diameter.

In some embodiments, the aqueous handling channels can be configured to preserve the integrity of their contents, in use. The aqueous handling channels may be used to introduce particulates suspended in aqueous media into the cartridge. Additionally or alternatively, the aqueous handling channels may handle a mixture of fluid components or a solution. The aqueous handling channels can be particularly useful for introducing biological and/or chemical entities such as cells, beads and/or reagents into the emulsifier.

The surfaces of the aqueous handling channels can be formed and/or treated to enable laminar flow through the channel. This can be particularly useful for reducing air bubbles within the channels. Additionally or alternatively, the aqueous handling channels may be coated with a coating layer configured to prevent adhesion of the biological and/or chemical entity to the walls of the aqueous handling channels. Moreover, the coating may also reduce shearing within fluid flows. Hence, the geometry of the aqueous handling channels and/or treatment of the surfaces of the aqueous handling channels provide suitable conditions for handling cells. The coating may also reduce roughness and imperfections in the aqueous handling channels, such as those caused by machining or moulding with a machined mould. Such imperfections may also be removed or reduced through processes such as polishing or annealing.

The selection of a material used to form the channels and channel walls has a critical impact on the integrity of the emulsion and of bioparticle suspensions as they travel through the channels. The material used to form the channels can reduce the wetting of droplets onto the channel walls. In addition, the material used can also reduce or eliminate adhesion of bioparticles onto the channel walls. Furthermore, certain materials will produce smoother, higher-fidelity channels and more accurately reproduce physical structures that are moulded in them.

In some embodiments, the channels are formed of Cyclic Olefin Copolymer (COC). In some embodiments, the channels are formed from Cyclic Olefin Polymer (COP). In other embodiments, the channels are formed from any of Polycarbonate (PC), Polydimethlysiloxsane (PDMS), Silicone rubbers, thermoplastic elastomers. Any of the aforementioned materials may be augmented with pigments that improve the visual appearance of the materials. In some embodiments, the pigments may increase the optical absorption of the material such that it becomes suitable for bonding via laser welding.

A number of techniques can be used for the assembly and construction of the cartridge. The cartridge base may be manufactured through 3D printing, micro-milling, hot embossing or injection moulding to form a plate with channel structures on one or both sides of the plate. The injection moulding process may also introduce vias that interpose the channels, or alternatively these vias may be created through a post-mould process such as drilling, laser ablation, micromilling, abrasion, etching, punching or hot-tool cutting.

In order to seal the channels within the plate, there is provided a top and optionally a bottom capping layer. These capping layers may be formed with adhesive backed films and, after being cut to shape and perforated they may be applied directly to the cartridge base. Alternatively, a cut and perforated film may be laser welded to the cartridge base plate. The capping layer may alternatively be formed with foils, membranes, composites, blocks of plastic, ceramics or other suitable materials such as FR4, metals or glasses.

Gaskets may be over-moulded into the cartridge base plate. Gaskets are particularly used to seal the interfaces between sub-components of the cartridge such as between the base plate and the emulsifiers or between the base plate and the chip. Alternatively, the gaskets may be fixed in place with adhesives or with a contact fit in to retaining structures formed in to the cartridge or the sub-components.

Additional structures such as lids, caps, lid-retainers, glass chips and emulsifiers may be attached to the cartridge via a number of techniques. Emulsifiers may be attached using threaded retaining screws, adhesives or by laser welding them in to position. The oEWOD chip may be bonded in to place using retaining clips and or screws, laser welding or adhesives. Similarly, the lid retaining structures may be bonded into place using laser welding, retaining clips and or screws or through adhesives. Any of the additional structures can be manufactured using injection moulding, embossing, laser cutting, etching, micro-milling, 3D printing or any other suitable manufacturing technique.

Further structures may be added within or around the cartridge to provide reinforcement and protection. Such structures may include ridges, beams, rods or bars made from materials such as steel, aluminium, glass fiber composites, ceramics or plastics that prevent the cartridge from bending.

Electrical connections between the chip, the unique identifier chip and exposed terminals on the cartridge can be made through the use of wires, printed circuit board or flexible circuit boards. Advantageously, the use of flexible circuit boards permits complex routing of the electrical connections around the cartridge without the use of wiring looms.

When aqueous dispersions of particulates are pumped through channels, the dispersion may become non-uniform. Particulates may sediment through gravitational forces, flow focusing and shear within fluid flows. Particles may adhere to channel walls, permanently or temporarily. These effects are known to occur in microfluidic channels containing particulates of biomaterials such as cells and microbeads. The design of the cartridge is such that those channels which connect the input aqueous reservoirs to the emulsifiers i.e. the aqueous handling channels, are substantially straight and have smooth sidewalls; any curves within the channels are routed so as to maximise the radius of curvature of the channel. Where vias are required in the routing, they are minimised in number and the hydraulic diameter of the via is chosen so that it matches the hydraulic diameters of the channels which it interconnects. A via may be designed such that it has a tapered diameter at the proximal and/or distal ends in order to give a smooth transition in fluid flow between the channels which are interconnected by said via. In some embodiments, each emulsifier is a step emulsifier having a plurality of nozzles and wherein each of the nozzles is connected by a branched channel that has a curved geometry.

The curved geometry of each of the branched channels is advantageous as it reduces the accumulation of cells and/or beads that can be trapped at the corners of the channels. In addition, the curved geometry of the channel has fewer sharp twists and turns which reduces the level of disruption of the cells and beads as they pass through the branched channels.

Moreover, the curved geometry of the branched channels can help minimise the distance and therefore, less time is required for microdroplets to travel through the emulsifier. This is advantageous as it reduces the risk of microdroplets being accumulated within the branched channels and therefore, reduces the risk of several microdroplets merging with each other within the branched channels.

In some embodiments, nozzle height can be in the range 6 μm to 30 μm and the step change of the channel of the emulsifier can be between 20 μm to 200 μm.

In some embodiments, each of the step emulsifiers further comprises a support pillar located near the outlet of the emulsifier. The support pillar provided at the outlet of each step emulsifier can prevent excessive crowding of microdroplets. This in turn minimises the risk of damaging the microdroplet and/or reduces the risk of microdroplets merging with each other.

The cartridge may further comprise a shield. The shield can protect the cartridge and its contents from being exposed to environmental conditions. The shield may be integral to the cartridge. The shield can be particularly advantageous because it protects the cartridge from exposure to the environment whilst also controlling and/or maintaining conditions within the interior of the cartridge that is covered by the shield. As an example only, the shield can provide a thermal seal and/or a light seal for the cartridge.

Moreover, providing a shield over most of the cartridge features can significantly improve the safety and durability of the cartridge. For example, providing a shield over the cartridge can aid user interaction, keeping user's fingers away from the internal structures of the cartridge to the benefit of cartridge contents and user alike.

The shield can be made of a non-conducting material such as plastic. This can help protect both the user and the integers of the system from unwanted exposure to electrical current, thus preserving the integrity of the sample, the system and the user. Furthermore, the shield may provide structural integrity to the cartridge by making the cartridge more rigid and therefore, more robust.

The shield can contain ducts, structures and apertures that permit the ingress of temperature-controlled air to the interior structures of the cartridge, making the resulting structure particularly suitable for the incubation of cells such as mammalian cells, bacteria or yeast. The ducts and apertures provided in this manner may route warmed or cooled air around the cartridge.

In some embodiments, the cartridge may further comprise one or more lids configured to cover each inlet port. In some embodiments, at least four inlets ports are provided for introducing a sample into the cartridge. The provision of a plurality of inlet ports on the cartridge can be useful when different samples are required to be loaded into the cartridge for different experiments. By way of example only, the user may introduce a sample containing different cells into two or more inlets. The user can then cover each of the inlet ports with their respective lids.

In some embodiments, the cartridge may further comprise at least one reservoir. In some embodiments, the number of reservoirs is matched to the number of step emulsifiers so that each step emulsifier has a dedicated reservoir. This ensures that there is no cross contamination between step emulsifiers and also enables a different aqueous fluid to be provided to each step emulsifier if desired. In addition, there is at least one oil reservoir. In some embodiments, a single oil reservoir can be sufficient to supply oil to all of the step emulsifiers provided on the cartridge.

In some embodiments, the cartridge may further comprise at least one outlet port for dispensing the sample out of the cartridge. In some embodiments, the outlet port comprises a dispense nozzle. A detection module such as a camera may be provided at the outlet of the port to image the contents of the sample flowing out of the dispense nozzle.

The formation of drips at the outlet of the dispense nozzle is governed by the rate of liquid flow in to the nozzle, as well as the dynamics of drip relaxation, evaporation from the proximity of the tip and the physical properties of the nozzle. This includes the size and shape and material of the nozzle.

The nozzle may be formed of PTFE, Teflon, PEEK, Polyimide, Steel, Aluminium, Glass, fused silica, although it will be understood that other suitable materials are available. It may be a composite of the aforementioned materials. In some embodiments, it may be a composite of steel internally lined with PTFE, or it may be a composite of fused silica externally jacketed with polyimide. In some embodiments, it may be a glass or fused silica nozzle coated with a hydrophobic material such as a fluorosilane. In some embodiments, the coating material may be oleophillic.

Any of the materials may be coated with an anti-fouling material and/or a hydrophobic material. The hydrophobic material may prevent the wetting of droplets on to the interior or exterior of the dispense tube. A coating may be used to modify the dripping behaviour of the tip.

Advantageously a tube formed of fused silica allows for the detachment of smaller drips, ensuring that the minimum possible volume is ejected from the chip and maximising the throughput of droplets dispensed.

In some embodiments, the cartridge may further comprise an optical inspection region, which may be provided between the outlet port and the chip. In some embodiments, the inspection region is suitable for imaging with a camera.

In some embodiments, the dispense path may comprise a buffer loop connected to ports on the rotary valve that allow droplets to be injected in to the buffer loop and then, through a repositioning of the rotary valve, ejected from the buffer loop in to the dispense nozzle.

In some embodiments, there is also provided an accompanying instrument which controls and monitors functions of the cartridge through a variety of mechanisms. For some embodiments, these mechanisms may include pneumatic pressure, optical readout and manipulation, electrical control and motion controls. Typically, the instrument will be a piece of laboratory apparatus designed for repeated long-term use, whilst the cartridge will be a consumable component designed for a single use or having a finite usage lifetime. In some embodiments, the cartridge may be partially reusable or wholly reusable.

In some embodiments, the cartridge may further comprise an alignment feature provided on the surface of the cartridge for ensuring correct alignment of the chip in the cartridge. The alignment features provided on the cartridge can be helpful in enabling the user to correctly position the cartridge within an instrument.

In some embodiments, the cartridge can be positioned within an optical set up containing one or more light sources for this purpose. For example, the alignment feature can be used to position the cartridge relative to a first light source e.g. a light source provided above the cartridge. The first light source may be used for generating sprite patterns for oEWOD.

The cartridge may also be positioned correctly via alignment features in such a way to enable a second light source to be used to inspect the contents of the microdroplets. The second light source may be provided perpendicular to the first light source.

The alignment feature can be provided in the form of one or more apertures and/or one or more pins located on the surface of the cartridge; one or more holes within the body of the cartridge and structures provided on the edges of the cartridge and/or shield. In some embodiments, a rail on the far edge of the cartridge mates with a groove in the instrument.

In some embodiments, at least one of the reservoirs is an input oil reservoir and the cartridge further comprises a rotary valve configured to connect the input oil reservoir to the step emulsifier.

In some embodiments, the cartridge may further comprise a second rotary valve configured to control the output of the chip to the outlet port of the cartridge. The second rotary valve can be used to transport the microdroplet from the oEWOD chip to the dispense nozzle located at the outlet port of the cartridge. The second rotary valve may be configured to control the dispensing of the microdroplet to one or more waste reservoirs on the cartridge.

In some embodiments, the cartridge may further comprise a pneumatic manifold configured to introduce pressure to the cartridge. The manifold allows for pressurisation of fluid reservoirs that are embedded into the cartridge. The pressure source may be provided from an instrument pressure supply that can be automatically be connected to the pneumatic manifold. The pneumatic source can be in a form of a pump configured to apply positive pressure to the cartridge. Additionally or alternatively, the pump may be configured to provide a vacuum within the cartridge. These pumps may be provided within the cartridge structure, or, conversely, they may be provided within the associated instrument. An advantage of the application of pneumatic pressure from the instrument is that such a configuration ensures that the instrument never comes into contact with biofluids or other reagents which could contaminate the instrument. Furthermore, the provision of a pump within the disposable cartridge structure will increase the cost and complexity of the cartridge.

In some embodiments, one or more micro-porous filters may be provided on the cartridge to reduce or eliminate cross-contamination of the instrument and cartridge. Such filters may be formed of air-permeable structures that prevent the ingress of cells, viruses or other bioparticles whilst permitting the transit of air. Such filters may also prevent the ingress of fluids. The size and area of the filters must be selected such that the filter does not impede the flow of air to pressurise the reservoirs.

In some embodiments, the cartridge may further comprise a unique identifier. The unique identifier on the cartridge can be in the form of a series of numerical indicia, a barcode, ID, an EEPROM or other form of non-volatile computer memory, an RFID tag, a transponder or a serial code. In some embodiments, the identifier can be used to store information which can then be extracted to inform the user of certain workflows, capacity limit, re-usability of the cartridge; expiry date of the cartridge. Various other data relating to specific experimental workflows or other information associated with the cartridge could also be included. The unique identifier may particularly be suited to machine-reading such as through a barcode scanner, an RF scanner or an electrical connection to terminals provided on the cartridge.

In some embodiments the cartridge is a consumable part suitable for one single use; in some cases it is suitable for 2, 3, 4, 5 or 6 uses but is suitable for a finite number of uses, for example less than 10 or less than 20 repeat uses. The number of uses and the usage history of each cartridge may be recorded by making an update to memory on the cartridge. Alternatively the number of uses and usage history can be recorded by the instrument such that for each unique cartridge the usage history is stored. This store of cartridge usage may be shared with other instruments or with a central server using a network connection.

In some embodiments, the instrument or associated control software can restrict the number of re-uses of a cartridge or restrict the exact sequence of workflow allowed on the cartridge on the basis of its usage history.

In some embodiments, the plurality of step emulsifiers can be oriented such their inlets and outlets are parallel to each other. In some embodiments, up to eight step emulsifiers can be provided on the surface of the cartridge to generate a continuous stream of uniform and monodispersed microdroplets. The parallel configuration of the inlets and outlets is to ensure that all the input paths have similar lengths and number of corners, preserving emulsion integrity and making emulsion integrity consistent between paths. This minimises the amount of variation the software has to deal with when loading droplets on to the chip. For example, when emulsion enters the chip in a very high-density state it may be more difficult for an image recognition algorithm to identify individual droplets and/or it may be more difficult to pick up droplets using an optical electrowetting pattern and/or the emulsion may be more prone to wetting the chip surface. Conversely, if the emulsion enters the chip in a very low-density state the rate of loading droplets in to the chip may be prohibitively slow. As such, it is imperative to control the density of emulsion provided through the emulsion handling channels in to the chip.

As another example, if the emulsion is introduced to the chip in a polydisperse state a large number of droplets may need to be rejected from the input as unsuitable for loading in to the chip. In the case where very large droplets are present in a polydisperse emulsion, it may become impossible to handle the oversized droplets within the optoelectrowetting chip. In the case where very small droplets are present in a polydisperse emulsion, they may not experience the electrowetting force within the chip and as such be impossible to control.

In some embodiments, the cartridge may further comprise at least one waste container. The waste container can be configured to store unwanted fluids within the cartridge, so that it can be taken out of the chip by the user at a convenient time. Furthermore, it prevents the fluids from being ejected from the cartridge immediately and if required, the fluids can be recycled. In addition, the waste container storing unwanted fluids can help minimise or prevent cross contamination of fluids within the cartridge.

In some embodiments, the emulsifier such as a step emulsifier may be injection moulded. The step emulsifier may be injection moulded which can be cost effective. In addition, the step emulsifier can be provided to generate large and regular numbers of microdroplets. The generated microdroplets would be of high integrity in order to be used for oEWOD or EWOD manipulation.

Furthermore, by manufacturing the step emulsifier via injection moulding technique allows for flexibility in design. For example, different heights and depths can be achieved within the channel of the each of the emulsifiers during the injection moulding process.

The emulsifier may be manufactured by a hot embossing process or a soft lithography process either of which has the advantage that the side-walls of the emulsifier may be vertical rather than drafted.

Additionally or alternatively, the emulsifiers may be formed by etching including reactive ion etching. This can be advantageous because it provides a smooth surface. Moreover, manufacturing the emulsifier by etching can be highly accurate and cost effective, as well as providing vertical sidewalls. Additionally or alternatively, the emulsifiers may be formed by ablation or micro-milling, as these techniques are suitable for producing parts with disparate range of critical structural dimensions such as the nozzle height dimension in the emulsifiers. In some embodiments, different areas of the emulsifier are formed with different manufacturing techniques.

According to an aspect of the present invention, there is provided a use of the cartridge according to any one of the aspects of the invention.

According to an aspect of the present invention, there is provided an entity or species screened by the device, apparatus, cartridge or method as disclosed herein.

According to an aspect of the present invention, there is provided an entity or species selected by the device, apparatus, cartridge or method as disclosed herein.

According to an aspect of the present invention, there is provided an entity or species isolated by the device, apparatus, cartridge or method as disclosed herein.

According to an aspect of the present invention, there is provided an entity or species made by the device, apparatus, cartridge or method as disclosed herein.

The entity or species may be chemical, biochemical, or biological in nature.

For example, the present invention may provide an agonist/antagonist to an entity as identified by the screening, selection and/or isolation method disclosed herein. The present invention may provide an agonist/antagonist to an entity as identified by the screening, selection and/or isolation method disclosed herein, for use in therapy. The entity may be chemical, biochemical, or biological in nature.

According to an aspect of the present invention, there is provided a use of the device, apparatus, cartridge, method, biological and/or chemical entity or species as disclosed herein.

According to an aspect of the present invention, there is provided a use of the device, apparatus, cartridge, method, biological and/or chemical entity or species as disclosed herein in therapy.

The present invention may provide for a use of the device, apparatus, cartridge, method, biological and/or chemical entity or species as disclosed herein in making a product. The product made may be chemical, biochemical, or biological in nature.

The use may be peptide synthesis. The use may be synthetic biology. The use may be cell line engineering or development. The use may be cell therapy. The use may be drug discovery. The use may be antibody discovery.

According to an aspect of the present invention, there is provided a use of the device, apparatus, cartridge, method or species as disclosed herein in analysis.

The analysis may be physical, chemical, or biological.

The use may be sub-cellular imaging. The use may be high content imaging.

The use may be diagnostics.

The use may be a biological assay. The biological assay may be high throughput screening. The biological assay may be ELISA.

The use may be cell secretion.

The use may be QC safety profiling.

The invention will now be further and more particularly described, by way of example only, and with reference to the accompanying drawings, in which:

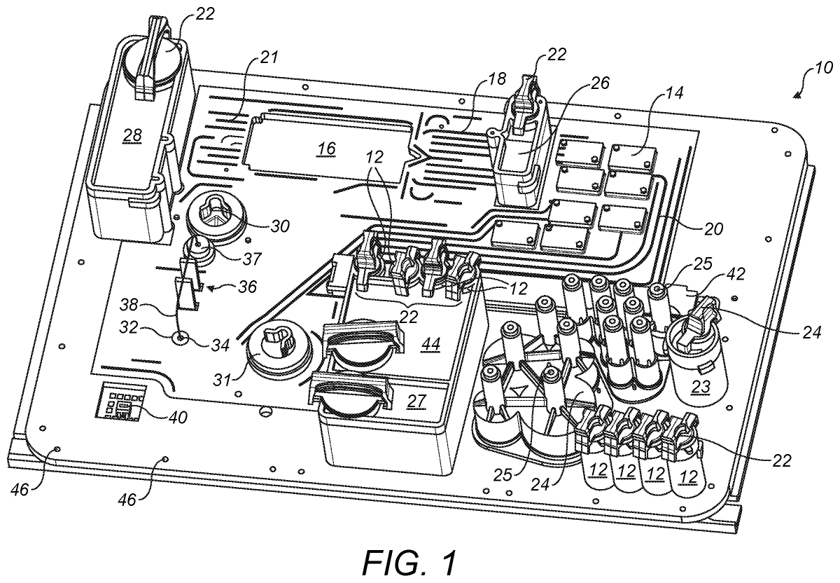

FIG. 1 shows a cartridge according to the present invention;

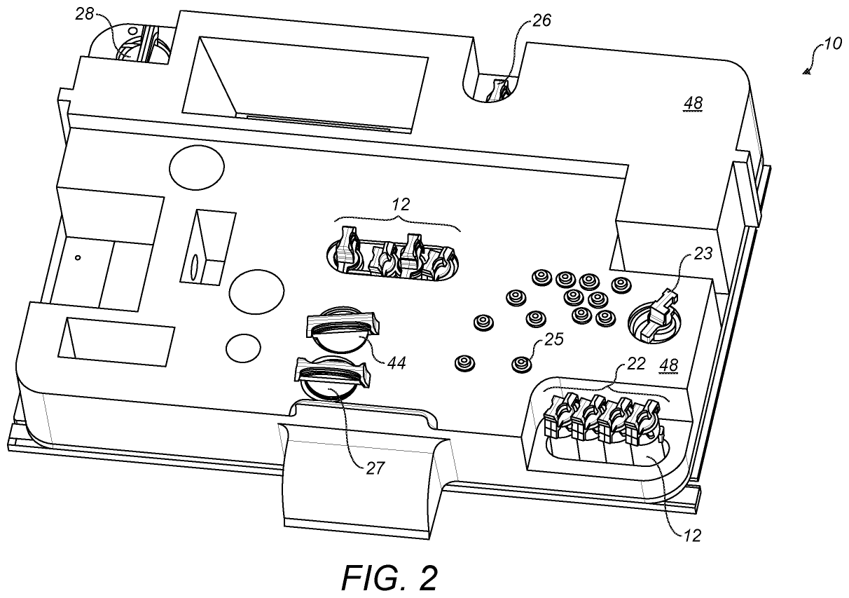

FIG. 2 shows a shield provided over the cartridge according to FIG. 1;

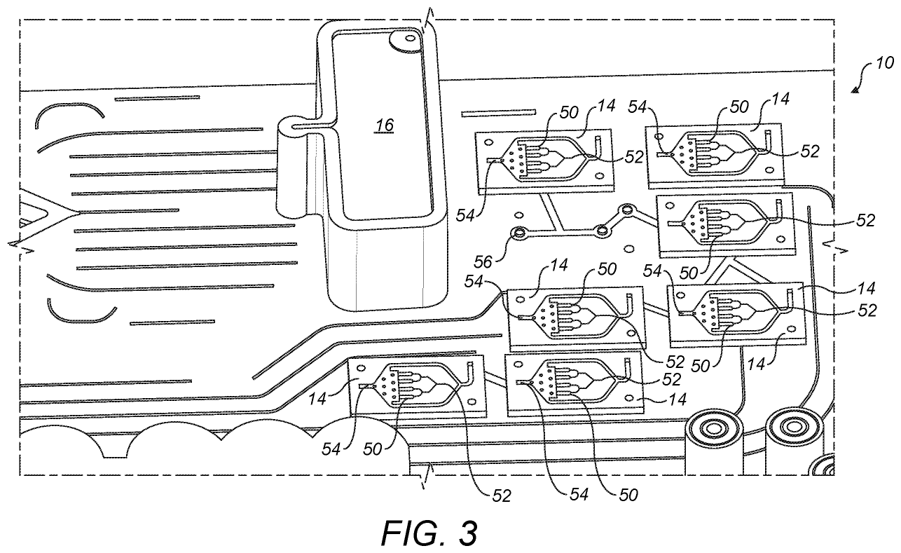

FIG. 3 shows a plurality of emulsifiers provided within the cartridge;

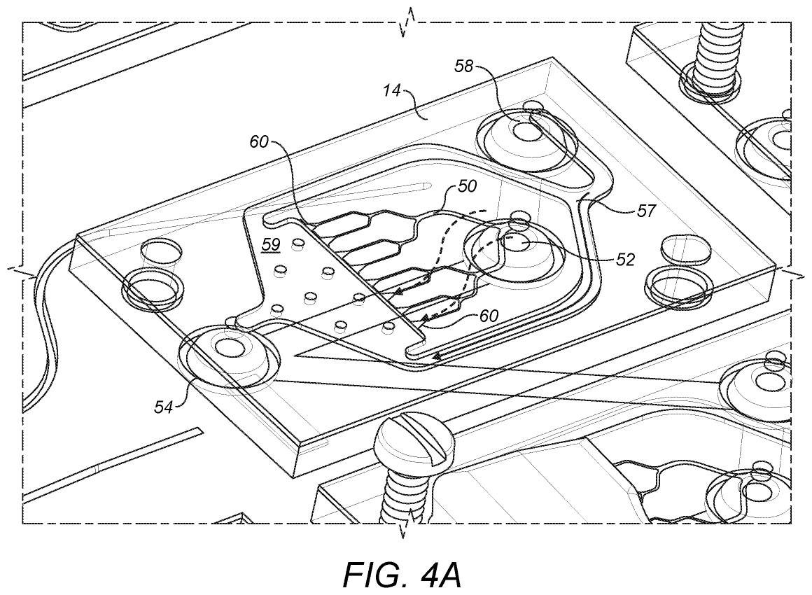

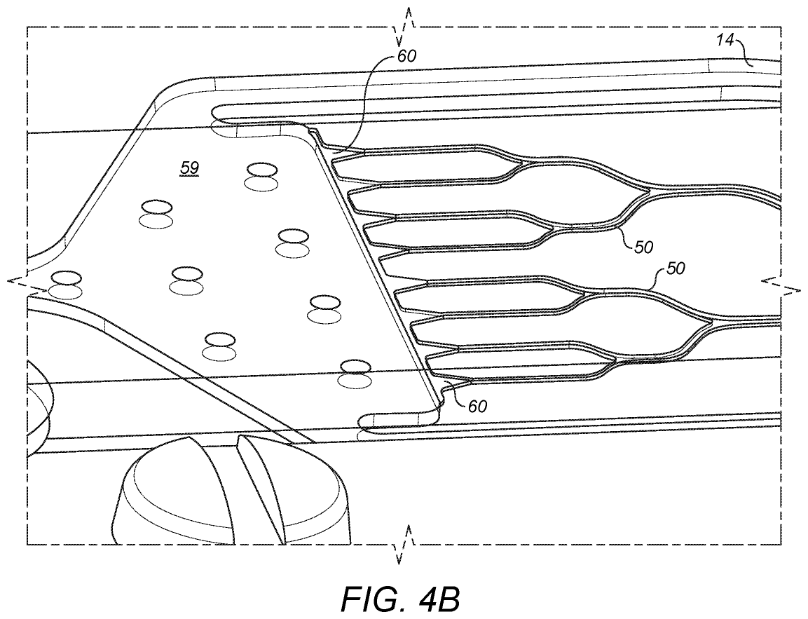

FIG. 4A provides an alternative view of the emulsifiers provided within the cartridge;

FIG. 4B shows a plurality of nozzles in one emulsifier;

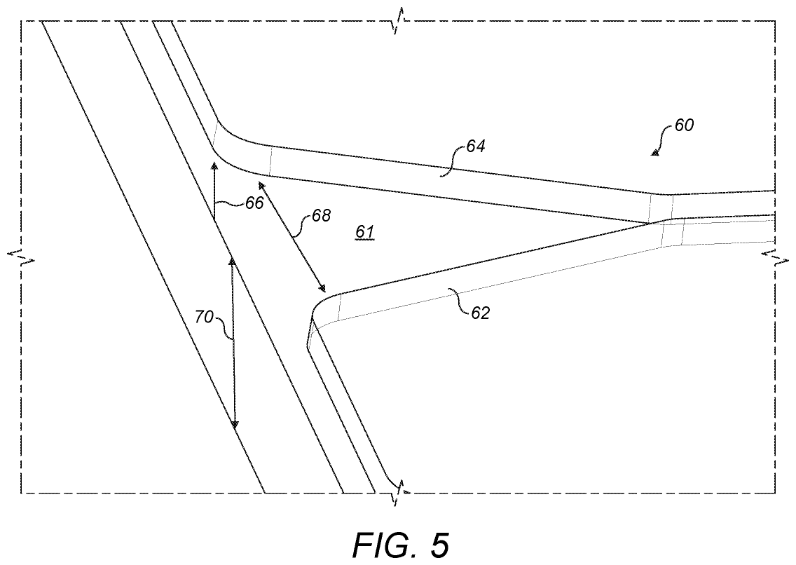

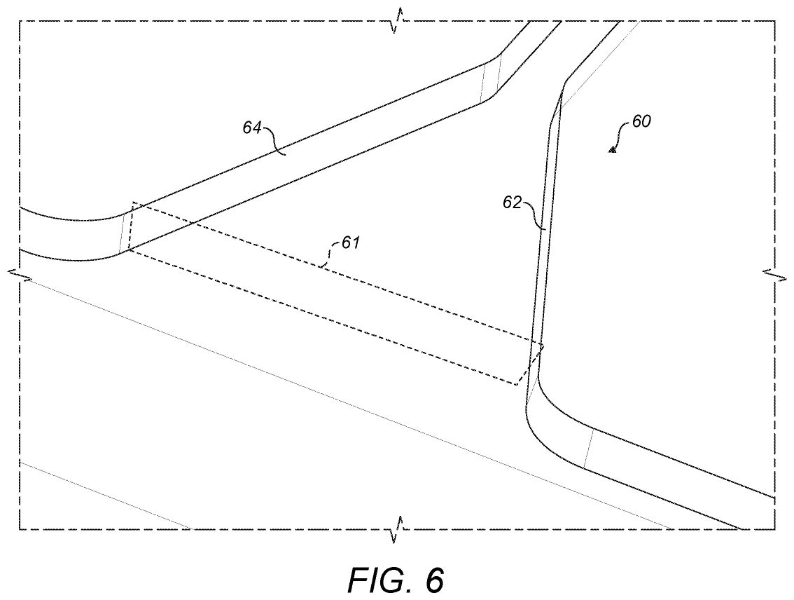

FIGS. 5 and 6 show the nozzle of the emulsifier;

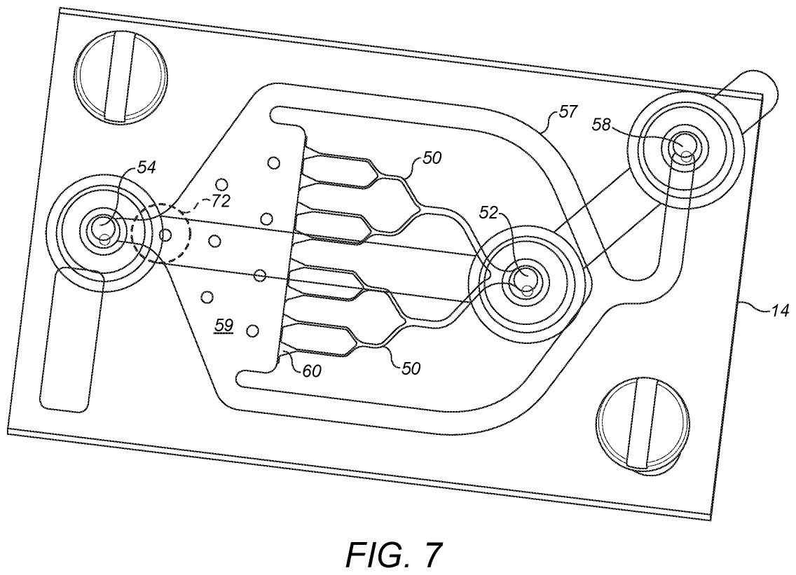

FIG. 7 provides a view of the support pillar provided near the outlet of the emulsifier;

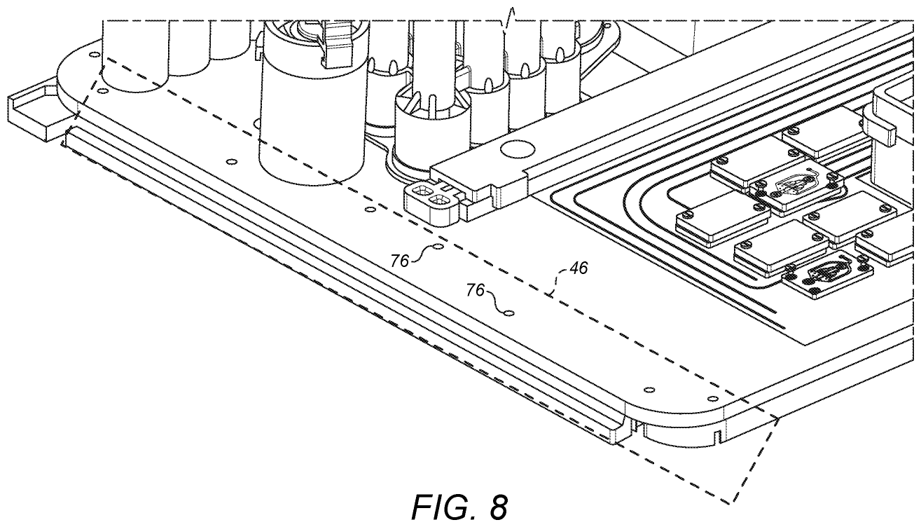

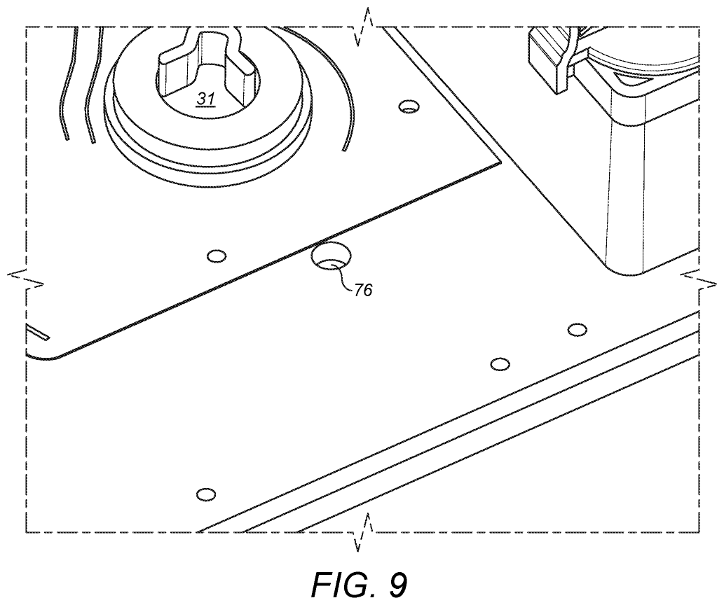

FIG. 8 provides an illustration of an alignment feature provided on the surface of the cartridge;

FIG. 9 shows one or more pins located on the surface of the cartridge;

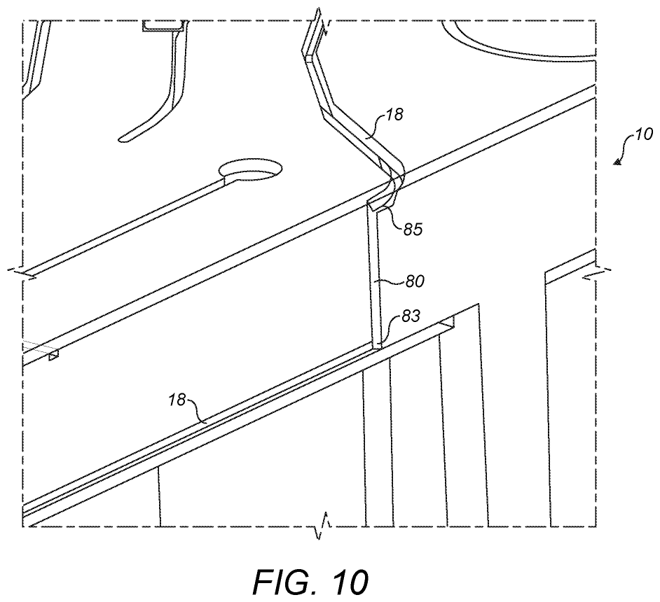

FIG. 10 shows a via structure connecting between two layers of the microfluidic channel structure;

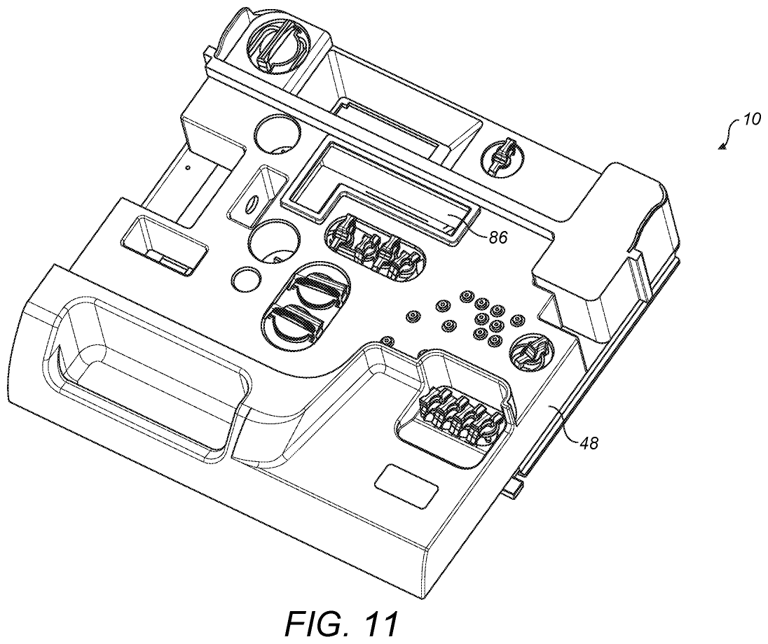

FIG. 11 shows a shield with an air ingress duct provided over the cartridge

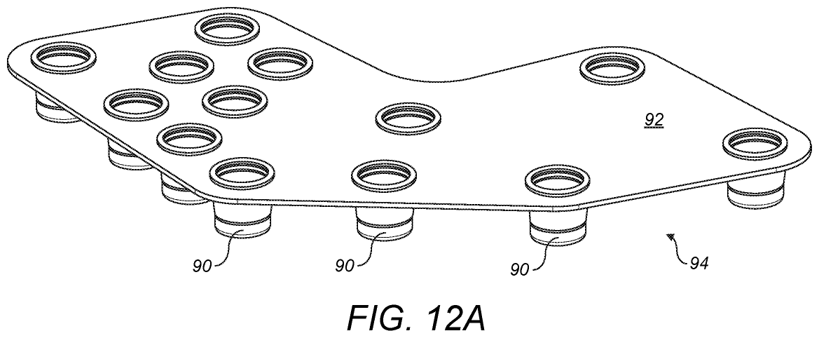

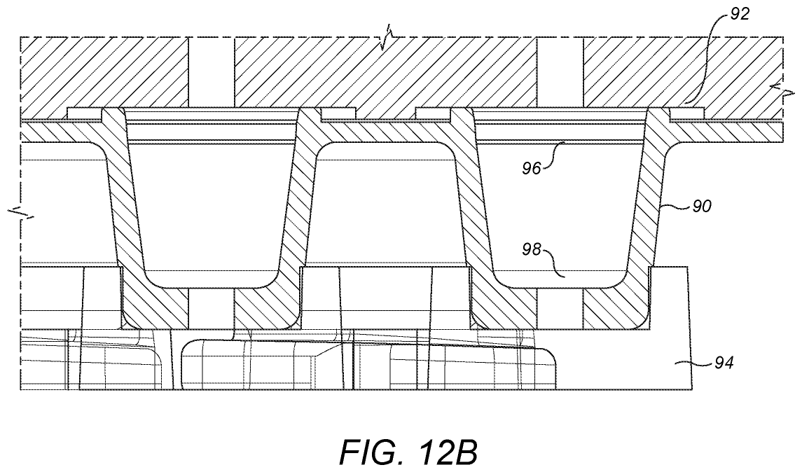

FIGS. 12A and 12B show a pneumatic gasket of the cartridge according to the present invention;

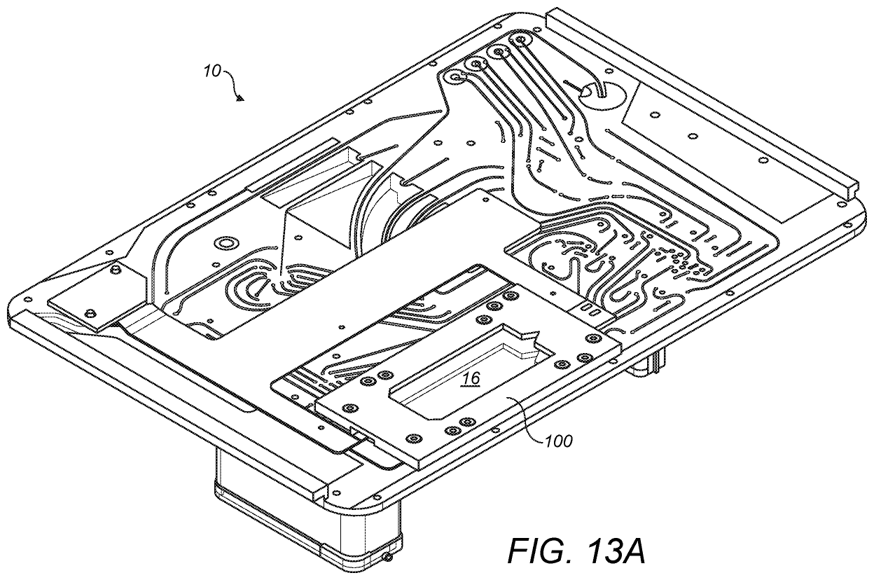

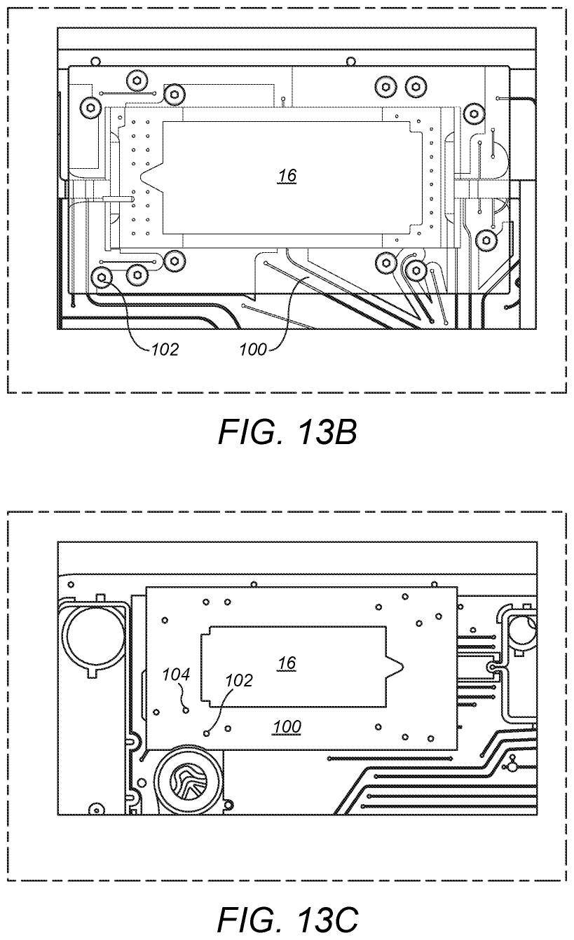

FIGS. 13A, 13B and 13C illustrate a mechanical assembly within the cartridge; and

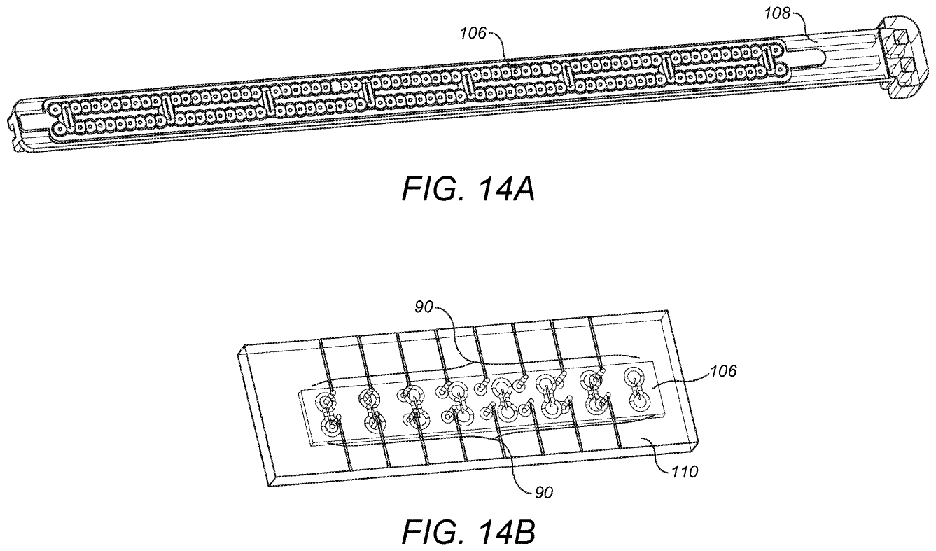

FIGS. 14A and 14B show a slide valve.

Referring to FIG. 1, there is provided a cartridge 10 having at least one inlet port 12 for introducing a sample into the cartridge 10. As shown in FIG. 1, the cartridge has up to eight inlet ports 12 for introducing the sample into the cartridge 10. The sample can be a fluid sample, such as a liquid sample, and the sample may contain at least one biological and/or chemical entity. The sample may be an aqueous media, a buffer solution, a suspension or a particulate.

The biological and/or chemical entity can be a cell, a biomolecule, a protein or a polypeptide such as a hormone, enzyme, cell signalling molecule, signal transduction molecule, immunoglobulins and the like. The biological and/or chemical entity may be a nucleic acid, such as RNA, DNA or a hybrid thereof. The biological and/or chemical entity may be a chemical, such as a pesticide, a toxin, an antibiotic, a fuel, a pharmaceutical drug, a vaccine, an antiviral and the like. The biological and/or chemical entity can be a carbohydrate, an antibody or a fragment thereof, a microbead, a particle, a compound and/or a drug.

Other biological and/or chemical entities may also be viruses, stimulants, cytokines, nutrients and/or dissolved gases. The cells may be of the same type, for example they are B cells or T cells (lymphocytes). It may be desirable to analyse co-cultures where the cells within the droplets are of disparate types such as a combination of reporter cells and primary cells, or a culture combining epithelial cells of different phenotypes to form a tissue-like structure.

The cell(s) may be natural. The cell(s) may be artificial. The cell(s) may be microcells. The cell(s) may be a biological cell. The biological entity may be part(s) of a cell(s), for example nuclei and/or mitochondria.

The cells may be taken from any appropriate source, for example a cell sample from a human or animal, plant or microorganism.

The cell may be a cell from a human or animal, optionally a mammal. The cell may be a plant cell, insect cell, fungal cell, bacterial cell or ameobal cell. The cell may be a cell-fusion such as a hybridoma.

The cells may be taken from a cell culture, for example a culture of stem cells, pluripotent cells, genetically engineered cells and the like.

If the cell is derived from a sample/biological sample this may be any human, animal, environmental (natural, contrived or modified), or food sample containing at least one cell type. The sample/biological sample may be selected from: stool, peripheral blood, sera, plasma, ascites, urine, cerebrospinal fluid (CSF), sputum, saliva, bone marrow, synovial fluid, aqueous humour, amniotic fluid, cerumen, breast milk, broncheoalveolar lavage fluid, semen, prostatic fluid, cowper's fluid or pre-ejaculatory fluid, female ejaculate, sweat, faecal matter, hair, tears, cyst fluid, pleural and peritoneal fluid, pericardial fluid, lymph, chyme, chyle, bile, interstitial fluid, menses, pus, sebum, vomit, vaginal secretions, mammary secretions, mucosal secretion, stool water, pancreatic juice, lavage fluids from sinus cavities, bronchopulmonary aspirates, blastocyl cavity fluid, and umbilical cord blood. Alternatively, the sample may come from a tissue sample.

The cell may be isolated from a patient or individual. The cartridge of the present invention as described herein may be used to screen such cells and return them to the patient (autologous cell transfer). The cells may be isolated from one individual and selected to be administered to a patient (allogenic cell transfer).

For some embodiments, the panel of microdroplets containing at least one cell contain cells of the same type, for example lymphocytes such as T cells. Therefore, the cells may be pre-selected prior to their inclusion into microdroplets. However, some contamination may occur with any biological cells wherein cells of a different type may also be included within the microdroplets, for example, B cells when T cells are the desired type.

For some embodiments, there may be a diverse population of cell types included in the panel of microdroplets, such as if an environmental sample is being screened with unknown bacterial cells present.

The cell may be a human or mammalian cell. The cell may be any suitable type from any tissue type, such as from organ or tissue of the body.

The cell may be an immune system cell. Such cells include monocytes, macrophages, osteoclasts, neutrophils (polymorphonuclear leukocytes) dendritic cells, microglial cells, mast cells, T cells (including helper T cells, regulatory T cells, cytotoxic T cells and natural killer T cells), B cells, natural killer cells and hematopoietic stem cells.

The cell can be a CHO cell or it can be a Jurkat cell. In some examples, Chinese hamster ovary (CHO) cells are modified to produce an immuno-therapeutic drug (e.g. a TCR) and then emulsified into microdroplets and loaded onto the microfluidic platform. Empty or multi-occupancy microdroplets are discarded. The remaining microdroplets containing single CHO cells are incubated on-chip to promote the production of the immunotherapeutic drug. The CHO containing droplets are then split to obtain multiple doses of the drug produced by each cell. T cells and target tumour cells are separately emulsified and loaded into arrays onto the microfluidic platform, adjusting the cell occupancy of each microdroplet as desired. The T cell and tumour cell arrays are then merged. A second merge operation is used to add a dose of immunotherapeutic drug, tracking which CHO cell each dose came from. The resulting assay is incubated and T-cell killing behaviour is monitored using the detection system by detecting caspase 3/7 fluorescence, a fluorescent marker of apoptosis. CHO cells that produced effective doses of the test drug can be dispensed from the device into a well plate.

The cell may be a pluripotent or stem cell, isolated or prepared via culturing techniques. The pluripotent stem cells may be reprogrammed mature cell types.

The cell may be genetically engineered prior to encapsulation into the microdroplet. The cell may be genetically engineered after encapsulation in the microdroplet.

Genetic engineering of the cell may be by any suitable method, including transduction (viral gene transfer), gene editing (using a nuclease such as zinc finger nucleases, TALEN, CRISPR/Cas9 base and prime editing) non-viral gene delivery (such as nanoparticle delivery), gene knock down, gene knock in and gene manipulation using RNA, for example, such as gene silencing or activation, or optogenetics. The genetic engineering generally involves the introduction of a genetic element into the cell, by any suitable means.

In some embodiments, the biological and/or chemical entity is any one or more of the following entities: an antibody; an antigen; a receptor; a substrate; an enzyme; a ligand; a nucleic acid; a cell; a part of a cell; an extracellular vesicle; a liposome; a polymer; a chemical; a drug; a FRET reporter; a chemiluminescent material; a sample of tissue; a virus or bacteriophage; a cytokine; and/or a protein.

The cartridge 10 further comprises at least one emulsifier 14 configured to produce microdroplets. A chip 16 is provided within the cartridge 10. The chip 16 comprises first and second composite walls having a microfluidic space therebetween for EWOD or oEWOD microdroplet manipulation. One or more emulsion handling channels 18 are provided on the cartridge 10 and are configured to transport the microdroplets from the emulsifier 14 to the chip 16 for EWOD or oEWOD operations. In addition, one or more aqueous handling channels 20 are provided on the cartridge 10 for introducing a fluid sample, such as an aqueous media, into the emulsifier 14.

In use, the sample containing a biological and/or chemical entity such as cells is loaded into the cartridge 10 via through one or more inlet ports 12. In some instances, there can be different samples containing different cell types being loaded into different inlet ports 12. The sample can be loaded into the cartridge 10 via through the inlet ports 12 at the start of any experiments. In some cases, a further sample may be loaded into the cartridge 10 via through the inlet ports 12 during an experiment. As shown in FIG. 1, each of the inlet ports 12 is provided with a lid 22. Once the sample is loaded into the inlet port 12, the user can close the lid 22 to protect the sample and seal the reservoir such that it can hold pneumatic pressure.

A pneumatic manifold 24 is provided within the cartridge 10. The pneumatic manifold 24 can be connected to an external pressure source (not shown in the accompanying drawings). In use, the pneumatic manifold 24 can apply pressure to the cartridge 10 to move the fluid sample along the channels 18, 20 within the cartridge. The pneumatic source 24 can be a pump configured to apply positive pressure to the cartridge 10. Alternatively, the pump may be configured to provide a vacuum within the cartridge 10. As shown in FIG. 1, the pneumatic manifold 24 comprises a cluster of O-rings 25, which functions as a seal to ensure that no air, gas or liquid can escape the cartridge 10. The pneumatic manifold may provide a connection to an external instrument that has a series of air outlets.

Aqueous handling channels 20 may be used to introduce particulates, a mixture of fluid components, a solution, a media and/or a suspension into one or more emulsifiers 14 under pressure. Aqueous handling channels 20 are substantially devoid of corners and have smooth sidewalls to preserve the integrity of the cells. The smoothness of the sidewalls may arise from the choice of material from which they are formed or it may arise from a post-treatment that minimises the risks of cells adhering to the sidewalls of the aqueous handling channels 20. The fluids flowing through the aqueous handling channels 20 are in laminar flow.

The cartridge 10 as shown in FIG. 1 also comprises emulsion handling channels 18. The emulsion handling channels 18 are provided between the emulsifier 14 and the chip 16. In use, the emulsion handling channels 14 are configured to transport microdroplets generated from the emulsifier 14 to the chip 16. The emulsion handling channels 18 have a rectilinear geometry. As shown in FIG. 1, the emulsion handling channels 18 are substantially straight channels in which the emulsion can flow without disruptive corners in order to maintain and preserve the integrity of the microdroplets.

As shown in FIG. 1, there is provided one or more emulsifiers 14. Up to 8 emulsifiers 14 are provided on the cartridge 10 although the skilled person in the art would understand that the number of emulsifiers can increase or decrease depending on the size and configuration of the cartridge 10. One or more emulsifiers 14 are configured to produce a stream of microdroplets that can then enter the EWOD or oEWOD chip 16 via through the emulsion handling channels 18. Advantageously, a monodisperse stream of microdroplets can be created with a varying flow velocity if a step emulsifier is used.

Referring to FIG. 1, there is shown a plurality of oil reservoirs 26, 27, 28 where one of the oil reservoir 26 is configured to supply oil to one of the emulsifiers 14. In addition, a further inlet port 23 is provided to supply oil directly to the emulsifier 14. Aqueous microdroplets generated from the emulsifier 14 are dispersed in the oil to form an emulsion. In some cases, a large single input oil reservoir 28 is provided to supply oil to all the emulsifiers 14 provided on the cartridge 10 all at once. The cartridge 10 further comprises a first rotary valve 30 configured to connect the input oil reservoir 28 with the emulsifier 14. The first rotary valve 30 can be configured to control the amount of oil that flows from the oil reservoir 28 into the emulsifier 14. A second rotary valve 31, shown in FIG. 1, is configured to control the dispensing of the microdroplet to one or more waste reservoirs 44 on the cartridge 10. As shown in FIG. 1, a further oil reservoir 27 is provided adjacent to the waste reservoir 44. In addition, the cartridge 10 contains one or more waste handling channels 21 that connect the outlet of the EWOD or oEWOD chip 16 to the waste reservoir 44. The waste handling channels 21 are configured to transport waste fluids from the chip 16 to the waste reservoir 44.

The cartridge 10 further comprises at least one outlet port 32 for dispensing the sample out of the cartridge 10. The dispensed sample may comprise one or more microdroplets. The outlet port 32 comprises a dispense nozzle 34. The dispense nozzle 34 can be configured to control the flow rate of the sample fluid out of the cartridge 10.

Between the outlet port 32 and the chip 16, there is provided an optical inspection region 36. The inspection region 36 is suitable for imaging with a camera. The camera can be used to image the contents of the sample flowing out of the dispense nozzle 34.

Referring to FIG. 1, there is shown a dispense path comprising a buffer loop 38 connected to a port 37 on at least one of the rotary valve 30. This allows the fluid, which may contain microdroplets, to be injected into the buffer loop 38 and then, through a repositioning of the rotary valve 30, the fluid containing microdroplets are ejected from the buffer loop 38 and into the dispense nozzle 34.

A unique identifier 40 is provided within the cartridge 10 for storing information that is unique to each individual cartridge 10. This enables the user to identify the specific cartridge 10 for use. The unique identifier 40 on the cartridge 10 can be in the form of a series of numerical indicia, a barcode, ID or a serial code.

A rail 42 located on the far edge of the cartridge 10, as shown in FIG. 1, mates with a groove in an instrument (not shown in the accompanying drawings) to ensure correct alignment of the cartridge 10 within the instrument. In addition, one or more alignment features 46 are provided on the surface of the cartridge 10 to ensure correct alignment of the chip 16 in the cartridge 10.

Referring to FIG. 2, there is shown a shield 48 provided to cover the cartridge 10. The shield 48 can protect the cartridge 10 and its contents from being exposed to environmental conditions. Thus, the shield can also be effective to help control and/or maintain conditions within the interior of the cartridge 10 that is covered by the shield 48. In one example, the shield 48 can provide a thermal and/or a light seal for the cartridge. As shown in FIG. 2, some of the inlet ports 12 of the cartridge 10 are partially or completely exposed to make them easily accessible to the user for introducing the sample into the cartridge. Each inlet port 12 comprises a lid 22. In addition, the further inlet port for oil 23, the oil reservoirs 26, 27, 28 the waste containers 44, and the O-rings 25 of the pneumatic manifold are partially exposed to provide access to the user.

Referring to FIG. 3, there is provided an illustration of a plurality of step emulsifiers 14 provided on the cartridge 10. Each step emulsifier 14 comprises branched channels 50 as shown in FIG. 3. The curved geometry of the branched channels 50 can ensure that the distance between the inlet port 52 and outlet port 54 of the step emulsifier is uniform for all the parallel flow paths, and thus, the flow resistance for every path through the emulsifier is substantially the same. This reduces the risk of the branched channels 50 running at different flow speeds and therefore, reduces the risk of biomaterials spending disparate amounts of time within the branched channels 50. Emulsifiers 14 can be bonded onto the surface of the cartridge 10 via by welding and gasketing 56.

Referring to FIG. 4A, the step emulsifier 14 contains an inlet port 52 configured to receive the sample fluid from the aqueous handling channels. The sample fluid flows, as indicated by the dashed arrow in FIG. 4A, through and towards the end of the branched channels 50 under pressure where a plurality of nozzles 60 are provided, as shown in FIGS. 4A and 4B. Once the microdroplets have been generated, they enter a microdroplet buffer zone 59 of the step emulsifier 14.

As shown in FIG. 4A, a separate port 58 is provided on the step emulsifier 14, which is configured to introduce oil, from the oil reservoir, into the step emulsifier 14. The oil represented by the solid arrow in FIG. 4A, bypasses the branched channels 50 and enters the microdroplet buffer zone 59 via through the bypass channels 57 of the emulsifier 14 where the formed aqueous microdroplets are dispersed into a carrier phase of oil. Droplets in the buffer zone remain under continuous lower-velocity flow as they transit the buffer zone. The microdroplets then exit the step emulsifier 14 via the outlet 54 of the step emulsifier 14 and enter into the emulsion handling channels to be transported to the chip.

Referring to FIG. 5, there is provided a nozzle 60 connected to one end of the branched channels 50 of the step emulsifier 14. The selection of the nozzle depth within the channel 70 of the step emulsifier 14 dictates the microdroplet size. As shown in FIGS. 5 and 6, the nozzle has a rectangular cross-section 61 with two drafted side walls 62, 64. Alternatively, the nozzle may have a different cross sectional geometry for example, it may be of a trapezoid profile. The nozzle 60 is configured to drip aqueous fluid into a carrier phase of oil. As the aqueous fluid flows through the nozzle 60, the height of nozzle h 66, determines the size of microdroplets that break off from the nozzle 60. The width of the nozzle w 68 may also influence the size of the microdroplets that are formed.

In some examples, the nozzle height h 66 can be in the range of between 6 to 30 μm, or it could be more than 6, 8, 10, 12, 14, 16, 18, 20, 22, 24, 26 or 28 μm. In some examples, the nozzle height h can be less than 30, 28, 26, 24, 22, 20, 18, 16, 14, 12, 10, or 8 μm. The width is always greater than the height.

In addition to the height and width of the nozzle 60, the step change of the channel 70 of the emulsifier can also create different microdroplet sizes as the aqueous fluid passes over the step. The step change of the channel 70 of the emulsifier can be between 100 to 250 μm, or it could be more than 100, 120, 140, 160, 180, 200, 220 or 240 μm. In some embodiments, the step change of the channel 70 of the emulsifier is less than 250, 240, 220, 200, 180, 160, 140 or 120 μm.

Referring to FIG. 7, there is shown a step emulsifier 14 comprising an inlet port 52 for introducing aqueous fluids into the step emulsifier 14 and an outlet port 54. A separate port 58 is provided on the step emulsifier 14, which is configured to introduce oil into the step emulsifier 14. The oil bypasses the branched channels and directly enters into the microdroplet buffer zone 59, via the bypass channels 57 of the emulsifier 14, where the formed aqueous microdroplets are dispersed into a carrier phase of oil. The step emulsifier 14 further comprises branched channels 50 connected to a plurality of a nozzle 60 and a support pillar 72 located near the outlet port 54 of the step emulsifier 14. The support pillar 72 provided at the outlet port 54 of the step emulsifier 14 can prevent excessive crowding of microdroplets at the outlet port 54 of the emulsifier 14, and thereby, minimises the risk of damaging the integrity of the microdroplet. The support pillar can be formed from the same substrate material that is used for the body of the step emulsifier.

Referring to FIGS. 8 and 9, the cartridge 10 further comprises one or more alignment features 46, which is provided on the surface of the cartridge 10 to ensure correct alignment of the chip 16 in the cartridge 10. The alignment feature 46 can be in the form of holes or pins 76. The holes 76 are provided within the body of the cartridge 10 and/or provided on the edges of the cartridge 10.

In addition, the alignment features 46 provided on the cartridge 10 may be used to enable the user to correctly position the cartridge within an instrument (not shown in the accompanying drawings) for read out of data by optical interrogation of the contents of the cartridge 10. As an example, the alignment feature is an aperture 76, which is located near one of the rotary valves 31 of the cartridge 10, as illustrated in FIG. 9.

Referring to FIG. 10, there is shown a cross-section of a through-via 80 provided between two emulsion handling channels 18 formed within the cartridge structure 10. The vias 80 can be used to route fluids between layers within the cartridge structure. Moreover, the dimensions of the vias 80 are chosen so that they match the hydraulic diameters of the emulsion handling channels 18 which they interconnect. In addition, the via 80 may be designed such that it has a tapered diameter at the proximal 83 and/or distal 85 end in order to give a smooth transition in fluid flow between the emulsion handling channels 18.

FIG. 11 shows a shield 48 covering the body of the cartridge 10. Within the shield 48, there is provided a duct 86 which permits the ingress of warm air to the body of the cartridge 10 and routes it to those areas, which may be incubating cells.

Referring to FIGS. 12A and 12B, there is shown a plurality of gaskets 90 that provides a pneumatic seal between two or more mating surfaces 92, 94 e.g. between the surfaces of two cartridges and/or between the surfaces of the cartridge and the instrument. The gasket 90 may be compressed by a wide range of heights depending on the requirements of the cartridge configuration in which the gasket is deployed.

As shown in FIG. 12B, the gaskets 90 can be in a cone-shaped or cup-shaped configuration. The cone or cup-shaped gasket 90 has a wide orifice at one end of the gasket 96, which is gradually tapered towards the opposite end 98 to provide a changing diameter. Various other configurations of the gasket will be apparent to the skilled person. The cone-shaped or cup-shaped gaskets 90 can be collapsible, which provides sealing pressure at a wide range of compressions. Therefore, the gaskets can be advantageous as they can prevent leakage from or into the mating surfaces whilst under compression.

In some embodiments, the gaskets can be provided to seal against rough or malformed surface(s) without leakage. In other embodiments, the gaskets can be provided to seal against any non-linear surface(s) e.g. surface(s) that are substantially non-parallel.

The collapsing cup or cone-shaped structure of the gasket can provide near-constant sealing pressure at a large range of compression heights. The dimensions of the gasket such as cup height and/or wall thickness, can be scaled to tune the compression and sealing behaviours. In some embodiments, the gasket can be re-shaped to match the different surfaces. This can provide multiple independent sealing sites on a first mating surface without sealing the second mating surface during compression.

The gasket may be made from a range of materials of varying hardnesses. For example, it may be made of a relatively soft Shore 50 silicone rubber polymer, or it may be made of a harder Shore 85 FKM rubber. A wide range of suitably compliant materials may be provided including silicone elastomers, FKM, FFKM, polyurethane, nitrile rubbers, natural rubbers, polyisoprene, neoprene and polyamides and more generally fluoroelastomers. Any of these materials may have a range of hardnesses.

Gaskets made from materials with a wide range of hardnesses can be advantageous as the gasket can have a soft (low shore hardness) part even when made of high hardness material. As referred herein and unless otherwise stated, the term “shore hardness” of a material refers to an indicative measure of the materials compliance response in a Shore Hardness test. This test is a measure of the materials local deformation by indentation, and is commonly known to the skilled person in the art to be an appropriate material selection criterion for a sealing elastomer structure. In addition, the high hardness material of the gasket may provide a robust interface that can prevent leakage.

A further advantage of the gasket disclosed herein is that it may provide a large range of compression without collapsing or occluding the orifices of the gasket. The gasket may comprise a sealing range that is largely independent of orifice size and shape. The gasket may be made of material(s) that does not occlude the orifice of the gasket upon compression. The gasket may also be suitable for moulding having tapered sidewalls and a structure that is suitable for release from a mould through minimising use of overhangs and having no internal cavities.

Additionally or alternatively, the cartridge may comprise a reinforcement feature (not shown in the accompanying drawings) which can be provided at the base (baseboard) of the cartridge i.e. bottom surface of the cartridge. The reinforcement feature may be made from, but is not limited to aluminium, steel, FR4 (a composite material composed of woven fibreglass cloth with an epoxy resin binder that is flame resistant). The FR4 is a grade designation for glass-reinforced epoxy laminate material. The reinforcement feature prevents bending of the cartridge and reduces or eliminates the deformation of the cartridge when pressurised or held in an instrument. Additionally or alternatively, the reinforcement material may be made from GFRP (Glass Fiber Reinforced Polymer), Carbon Fiber or another suitably strong composite material.

Referring to FIGS. 13A, 13B and 13C, there is provided a mechanical chip assembly 100 within the cartridge 10 that permits the removal and re-installation of the EWOD or oEWOD chip 16. The mechanical chip assembly or clamp 100 can be provided at the bottom or top surfaces of the EWOD or oEWOD chip 16, as shown in FIGS. 13B and 13C. The mechanical chip assembly/clamp 100 includes an upper support plate, a lower support plate, threaded inserts 102, optionally a plurality of self-tapping screws, a deformable gasket that provides a seal between the chip and that cartridge baseboard, optionally one or more hole(s) 104 for alignment pins to precisely position the chip within the baseboard. Optionally the clamp may be transparent. Advantageously, the clamp may allow the chip to be added to the cartridge at any point during the manufacturing process. Furthermore, the clamp allows the chip to be removed for cartridge re-work, and it enables the chip to be removed and replaced by the user.

Additionally or alternatively, the mechanical assembly or clamp provided within the cartridge may also permit the removal and re-installation of the step emulsifier. The features of the mechanical assembly may include a plurality of self-tapping screws, a threaded insert, an upper support plate, a lower support plate, a deformable gasket between the emulsifier and channel board, and an optional alignment feature to register the emulsifier to the baseboard of the cartridge.

Referring to FIG. 14A, there is shown an embodiment of the low force slide valve 106. The slide valve 106 can be made from a thermoplastic elastomer material such as TPE. As shown in FIG. 14A, the slide valve 106 can be provided on a support 108. Referring to FIG. 14B, there is provided an alternative embodiment of the slide valve 106. The slide valves 106 may be provided on the cartridge in order to control the opening of the aqueous reservoirs in a sequential manner. By opening the reservoirs one at a time, the user can accurately control the amount of aqueous fluids flowing within the cartridge.

In addition, the slide valves 106 provided on the baseboard 110 of the cartridge, as illustrated in FIG. 14B, can be relatively short and less flexible which reduces the actuation force required to overcome friction. In FIG. 14B, there is shown a number of gaskets 90 provided on both sides of the valve 106 in order to provide a seal in the intermediate closed positions. The gaskets 90 can pass over each other and may be lubricated and/or coated with a non-adhesive coating. The gaskets 90 may be coated with a low-friction coating that prevents adhesion between the gaskets and/or prevents adhesion between the moving and stationary parts of the valve body.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described. It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1. A cartridge comprising:
at least one inlet port for introducing a sample into the cartridge;
at least one emulsifier configured to produce microdroplets;
a chip comprising a first and second composite walls having a microfluidic space therebetween for microdroplet manipulation;
an emulsion handling channel configured to provide fluid communication between the emulsifier and the chip; and
an aqueous handling channel for introducing aqueous media to the emulsifier.

2. The cartridge according to claim 1, further comprising one or more vias connecting the emulsion handling channels.

3. The cartridge according to claim 2, wherein the vias have substantially the same hydraulic diameter as the emulsion handling channels.

4. The cartridge according to claim 2, wherein the vias and/or the channels leading up to the vias are tapered to provide a gradually changing hydraulic diameter.

5. (canceled)

6. The cartridge according to claim 4, wherein the aqueous handling channel is substantially devoid of corners and has smooth sidewalls of dimension between 100 μm and 400 μm.

7. (canceled)

8. The cartridge according to claim 1, wherein each emulsifier is a step emulsifier having a plurality of nozzles and wherein each of the nozzles is connected by a branched channel that has a curved geometry.

9. The cartridge according to claim 8, wherein the nozzle height is in the range 6 μm to 30 μm and the step change of the channel of the emulsifier is between 20 μm to 200 μm.

10. The cartridge according to claim 8, wherein each of the step emulsifiers further comprises a support pillar located near the outlet of the emulsifier.

11. The cartridge according to claim 1, further comprising one or more of a shield; one or more lids configured to cover each inlet port; at least one reservoir; a pneumatic manifold configured to introduce pressure to the cartridge; a unique identifier and at least one waste container.

12. (canceled)

13. (canceled)

14. The cartridge according to claim 1, further comprising at least one outlet port for dispensing the sample out of the cartridge.

15. The cartridge according to claim 14, wherein the outlet port comprises a dispense nozzle.

16. The cartridge according to claim 14, further comprising an optical inspection region, suitable for imaging with a camera, provided between the outlet port and the chip.

17. (canceled)

18. (canceled)

19. The cartridge according to claim 1, further comprising an alignment feature provided on the surface of the cartridge for ensuring correct alignment of the chip in the cartridge.

20. The cartridge according to claim 11, wherein at least one of the reservoirs is an input oil reservoir and wherein the cartridge further comprises a rotary valve configured to connect the input oil reservoir with the step emulsifier.

21. The cartridge according to claim 20, further comprising a second rotary valve configured to control the output of the chip to the outlet port of the cartridge.

22. (canceled)

23. (canceled)

24. The cartridge according to claim 1, wherein the plurality of step emulsifiers are oriented such their inlets and outlets are parallel to each other.

25. (canceled)

26. The cartridge according to claim 1, wherein the microdroplet manipulation configured to be performed by EWOD or oEWOD.

27. Use of a cartridge according to claim 1.
